(19) United States
(12) Patent Application Publication
(10) Pub. No.: US 2026/0247065 A1
(43) Pub. Date: Aug. 20, 2026

(54) SPEAKER

(71) Applicants: FOSTER ELECTRIC COMPANY, LIMITED, Tokyo (JP); DENSO TEN LIMITED, Kobe-shi, Hyogo (JP)

(72) Inventors: Seiichi Ishikura, TOKYO (JP); Kentaro MACHIDA, TOKYO (JP)

(21) Appl. No.: 19/148,227

(22) PCT Filed: Jan. 15, 2024
(86) PCT No.: PCT/JP2024/000853

§ 371 Date: Jul. 15, 2025

(30) Foreign Application Priority Data
Jan. 16, 2023 (JP) 2023-004734

(51) Int. Cl. H04R 1/28; H04R 7/12; H04R 9/02; H04R 9/04; H04R 9/06

(52) U.S. Cl. CPC H04R 1/2873; H04R 7/12; H04R 9/025; H04R 9/043; H04R 9/046; H04R 9/06; H04R 2400/11

(57) ABSTRACT

A speaker having a suitable structure for reduced thickness is provided.

The speaker 10 includes a magnetic circuit 40, a first vibration part 20, and a second vibration part 30. The magnetic circuit 40 includes a first magnet 42, a first magnetic member 41 attached to the first magnet 42, a first yoke 43 attached to the first magnet 42, and a second yoke 45. The first yoke 43 forms a first magnetic gap G1 with respect to the first magnetic member 41, and forms a second magnetic gap G2 with respect to the second yoke 45. The second vibration part 30 includes a weight 39.

### TECHNICAL FIELD

The present invention relates to a speaker.

### BACKGROUND ART

Patent Document 1 discloses a speaker device for realizing high-quality sound reproduction.

This speaker device includes a first magnetic circuit, a main body part having a function of emitting acoustic waves, a second magnetic circuit integrally formed with the first magnetic circuit, and a vibration suppression part. The main body part includes a first vibration part that is driven by the first magnetic circuit, and the vibration suppression part includes a second vibration part that is driven in the opposite direction to the first vibration part by the second magnetic circuit. The second vibration part applies, to the second magnetic circuit, vibration that cancels vibration applied to the first magnetic circuit by the first vibration part.

### PRIOR ART DOCUMENTS

### Patent Documents

Patent Document 1: Japanese Patent Application Laid-open (JP-A) No. 2006-13587

### SUMMARY OF THE INVENTION

### Problem to be Solved by the Invention

In the above-described technique, there is room for improvement as regards making speakers thinner.

An object of the present disclosure is to provide a speaker having a structure that is suitable for thickness reduction.

### Means for Solving the Problem

A speaker according to a first aspect includes: a magnetic circuit; a first vibration part vibrating in order to emit sound and having a first bobbin, a first coil, a first damper and a diaphragm; and a second vibration part vibrating in order to cancel vibration of the speaker as a whole that is due to the first vibration part, and having a second bobbin, a second coil, a second damper and a weight, in which: the magnetic circuit includes: a first magnet; a first magnetic member attached to the first magnet; a first yoke attached to the first magnet, a first magnetic gap being formed between the first yoke and the first magnetic member; and a second yoke, a second magnetic gap being formed between the second yoke and the first yoke, the weight is configured by a conductor that is a non-magnetic member, and a shape of the weight is substantially annular, having a notch at a part of a circumference.

In the present aspect, the speaker includes a magnetic circuit, a first vibration part that vibrates in order to emit sound, and a second vibration part that vibrates in order to cancel vibration of the speaker as a whole that is due to the first vibration part.

The first vibration part includes a first bobbin, a first coil, and a first damper, and the second vibration part includes a second bobbin, a second coil, and a second damper.

Further, in the present aspect, the magnetic circuit includes a first magnet, a first magnetic member, a first yoke, and a second yoke. The first yoke forms a first magnetic gap with respect to the first magnetic member, and forms a second magnetic gap with respect to the second yoke.

This enables the first yoke to be used as a path for both magnetic flux passing through the first magnetic gap and magnetic flux passing through the second magnetic gap, and thickness reduction of the magnetic circuit can be achieved.

Here, the second vibration part includes a weight.

This enables the amplitude amount of the second vibration part to be reduced while maintaining the force generated from the second vibration part, compared to an aspect in which the second vibration part does not include a weight. This enables the speaker to be reduced in thickness. Here, reducing the thickness of the speaker means miniaturizing the speaker in the vibration direction of the first vibration part; namely, reducing the overall height of the speaker.

Further, the weight is made of a conductive material such as a metal. This enables the mass of the weight to be easily secured, and enables a force generated from the second vibration part to be easily secured.

Further, the weight is made of a non-magnetic member such as aluminum. This prevents the weight from receiving unnecessary force from the magnetic field generated by the magnetic circuit.

Further, the shape of the weight is a substantially annular shape including a notch at a part of its circumference. As a result, current is prevented from flowing through the weight in an annular manner, and a strong force is prevented from acting on the weight, during a process of magnetizing the second magnet.

A speaker according to a second aspect of the present disclosure is the first aspect, in which the second bobbin protrudes upward relative to the weight.

In the present aspect, the second bobbin protrudes upward relative to the weight. In other words, the weight does not protrude toward the side of the first vibration part, which is above the second bobbin.

As a result, compared to an aspect in which, for example, a weight is disposed so as to be hooked onto the upper end of the second bobbin, the speaker is easily reduced in thickness.

A speaker according to a third aspect of the present disclosure is the first or second aspect, in which the second damper has two elastic bodies, and the weight is disposed between the two elastic bodies.

In the present aspect, the second damper includes two elastic bodies. As a result, movement symmetry and rectilinearity at the time of amplitude of the second vibration part are improved.

Further, the weight is disposed between the two elastic bodies. As a result, the weight does not adversely affect the thickness reduction of the speaker.

A speaker according to a fourth aspect of the present disclosure is any of the first to third aspects, in which the second damper has a first elastic body and a second elastic body disposed so as to overlap with each other in a vibration direction, the first elastic body has a recessed part recessed in a direction approaching the second elastic body in the vibration direction, and the weight is disposed in the recessed part at a face at an opposite side from the second elastic body.

In the present aspect, the second damper includes a first elastic body and a second elastic body that are disposed so as to overlap with each other in the vibration direction. Further, the first elastic body has a recessed part that is recessed in a direction approaching the second elastic body in the vibration direction, and the weight is disposed on a face of the recessed part at an opposite side from the second elastic body.

As a result, there is no need for an operation to arrange a weight between the first elastic body and the second elastic body, and dimensional expansion of the second vibration part in the amplitude direction can be suppressed.

A speaker according to a fifth aspect of the present disclosure is any of the first to fourth aspects, in which the weight is disposed surrounding the second bobbin. The weight is disposed with a gap between the weight and the second bobbin in a radial direction. The weight has a concave part that enlarges the gap between the weight and the second bobbin at a part in a circumferential direction of the weight.

In the present aspect, the weight has a concave part that enlarges a gap between the weight and the second bobbin at a part in a circumferential direction of the weight.

As a result, when soldering or the like is performed on the outer peripheral face of the second bobbin, by providing the concave part so as to correspond to the portion to be soldered, short-circuiting between the second bobbin and the weight due to solder debris, other metal components, or the like can be suppressed.

A speaker according to a sixth aspect of the present disclosure is any of the first to fifth aspects, in which a center of gravity of the weight and a center axis of the second vibration part are substantially the same.

In the present aspect, the center of gravity of the weight is substantially the same as the center axis of the second vibration part.

As a result, the linearity of vibration of the second vibration part can be satisfied.

A speaker according to a seventh aspect of the present disclosure is any of the first to sixth aspects, in which the second damper has an elastic body integrated with wiring.

In the present aspect, the second damper includes an elastic body that is integrated with wiring.

As a result, there is no need to provide a wiring placement space, which contributes to the reduction of the thickness of the speaker.

### BRIEF DESCRIPTION OF THE DRAWINGS

FIG. 1 is a cross-section of a speaker according to a first exemplary embodiment.

FIG. 2 is an exploded perspective view of a first vibration part.

FIG. 3 is an exploded perspective view of a second vibration part.

FIG. 4 is a perspective view of a coupler.

FIG. 5 is a cross-section end face view of a coupler.

FIG. 6 is a perspective view of a weight.

FIG. 7 is an enlarged view of a part of a frame.

FIG. 8 is a cross-section of a speaker according to a second exemplary embodiment.

FIG. 9 is a perspective view illustrating a weight according to a modified example.

### DESCRIPTION OF THE INVENTION

### First Exemplary Embodiment

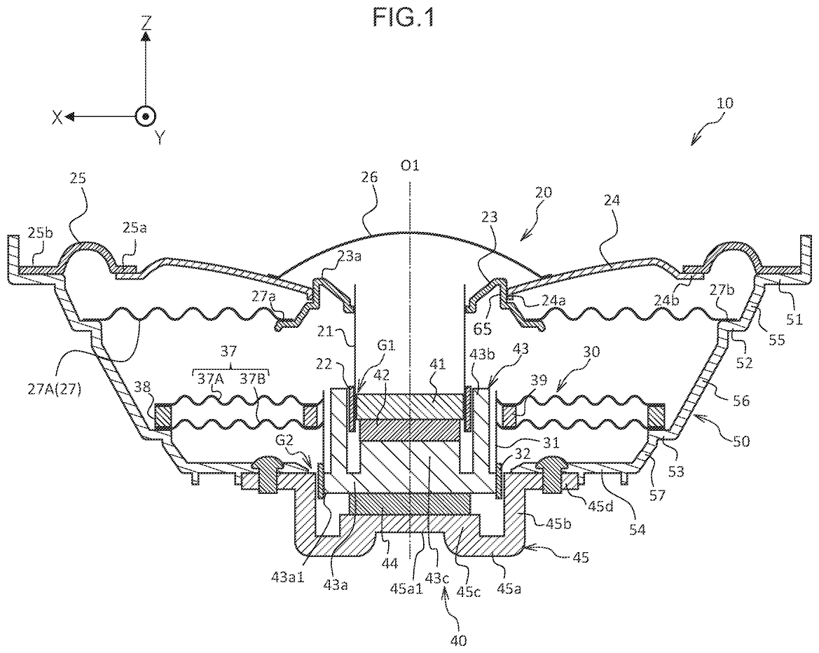

Explanation follows regarding a speaker 10 according to a first exemplary embodiment of the present disclosure, with reference to FIGS. 1 to 7. FIG. 1 is a cross-section along an XZ plane passing through a center axis O1 of the speaker 10.

The speaker 10 is installed in a vehicle door, for example. The speaker 10 is, for example, a woofer or a subwoofer, and is capable of bass sound reproduction at a large input. A main portion of the speaker 10 is axially symmetric with respect to the center axis O1.

The speaker 10 includes a first vibration part 20 that vibrates to produce sound, a second vibration part 30 that vibrates in order to cancel vibration of the entire speaker 10 that is due to the first vibration part 20, a magnetic circuit 40, and a frame 50 that supports these components.

In the following explanation, a direction parallel to the center axis Ol is referred to as an axial direction, a direction in the axial direction from the second vibration part 30 toward the first vibration part 20 is referred to as a forward direction or an upward direction, and a direction from the first vibration part 20 toward the second vibration part 30 is referred to as a rearward direction or a downward direction. Further, a direction perpendicular to the center axis O1 is referred to as a radial direction.

### First Vibration Part 20

The first vibration part 20 includes a first bobbin 21, a first coil 22, a first damper 27, a diaphragm 24, an edge 25, a cap 26, and a coupler 23.

The first bobbin 21 has a cylindrical shape that is coaxial with the center axis O1. The first coil 22 is formed by being wound around an outer peripheral surface of a rear end part of the first bobbin 21.

The diaphragm 24 is a member that emits sound by vibrating. The diaphragm 24 has a circular hole at the center that is coaxial with the center axis O1, and has a shape extending outward in the radial direction and in the forward direction from an inside edge part 24a that forms the circular hole.

The inside edge part 24a of the diaphragm 24 is joined to the coupler 23.

An outside edge part 24b of the diaphragm 24 and the frame 50 are connected by the edge 25. An inside edge part 25a of the edge 25 is joined to a front face of the outside edge part 24b of the diaphragm 24. The edge 25 is annular in shape, and has a U-shaped cross-section that is convex toward the front. An outside edge part 27b of the edge 25 is joined to the frame 50.

The first damper 27 supports the first bobbin 21 so as to be capable of vibrating along the center axis O1 direction. The first damper 27 is disposed at an outer side in the radial direction of the first bobbin 21 and at the rear of the diaphragm 24.

The first damper 27 is configured from a single elastic body 27A. The elastic body 27A has a circular hole at the center that is coaxial with the center axis O1, is an elastic body in the shape of an annular disk extending outward in the radial direction from an inside edge part 27a forming the circular hole, and has a corrugated shape (specifically, a shape that undulates back and forth in accordance with the position in the radial direction).

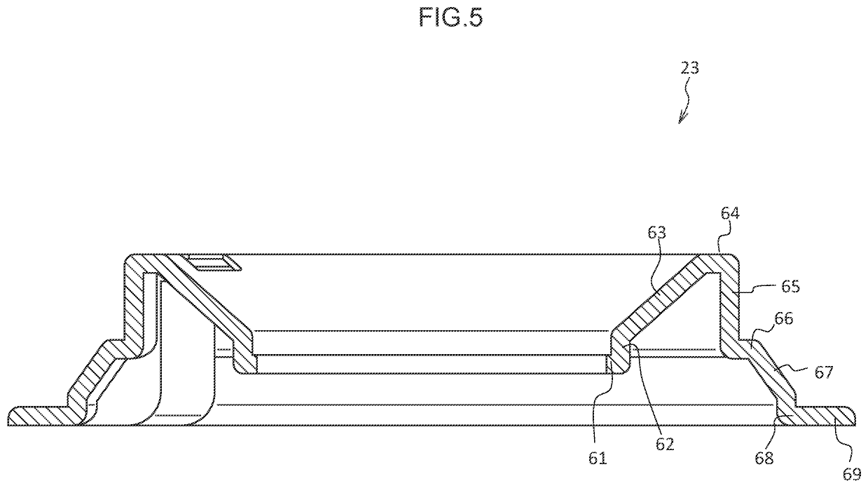

The inside edge part 27a of the elastic body 27A is joined to a front face of an outside edge part (a fourth horizontal part 69; see FIG. 5) of the coupler 23, and an outside edge part 27b of the elastic body 27A is joined to the frame 50.

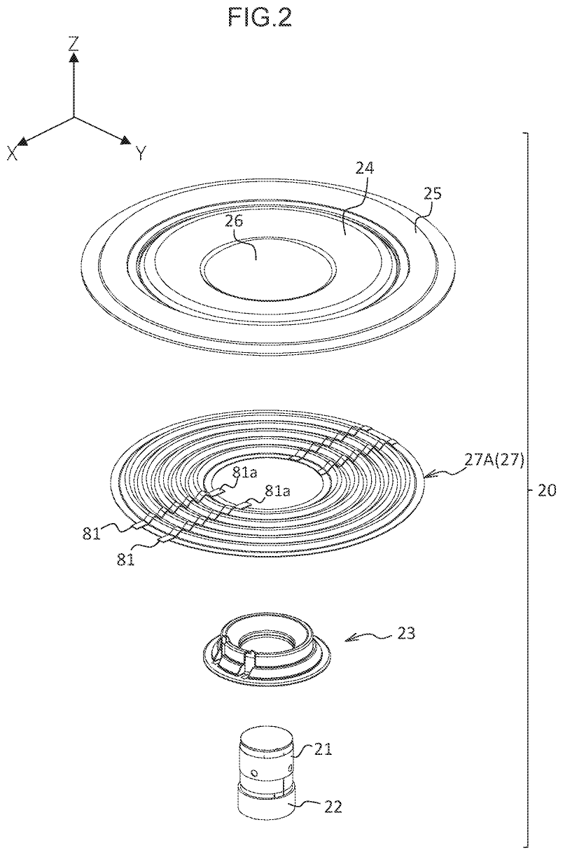

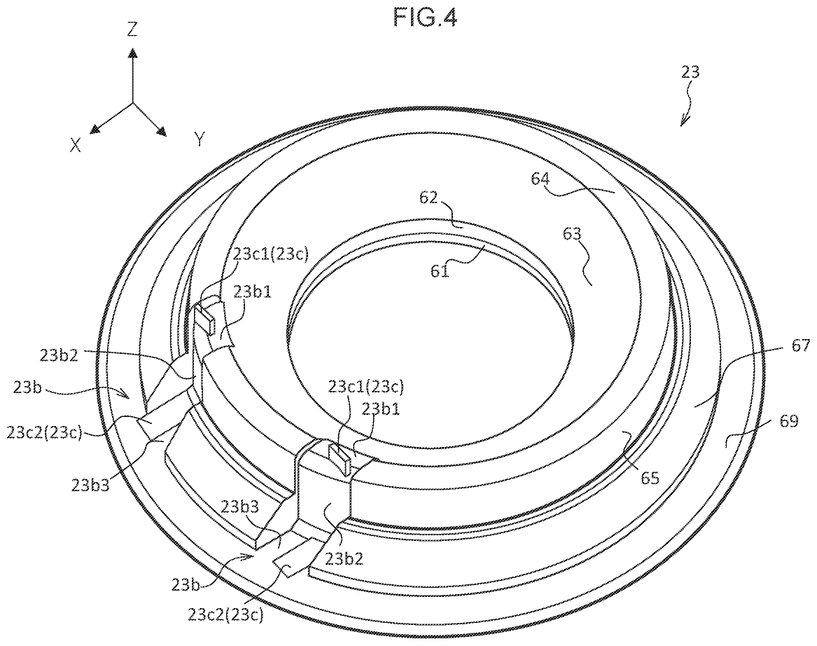

As illustrated in FIG. 2, two belt-shaped wirings 81 (wirings; transmission paths) are integrated into the elastic body 27A. Each belt-shaped wiring 81 is provided following the shape of the elastic body 27A at the front face side of the elastic body 27A. Namely, each belt-shaped wiring 81 has a waveform shape. The two belt-shaped wirings 81 are disposed at positions that are symmetrical in the Y direction, and respectively extend in parallel along the X direction. An inside connection part 82a of the belt-shaped wiring 82 is connected to a second extension part 23c2 (see FIG. 4) of a relay member 23c, described below.

The cap 26 is a member that emits sound by vibrating. The cap 26 covers the first bobbin 21 and the coupler 23 from the front. An outside edge part of the cap 26 is joined to the front face of the diaphragm 24.

The coupler 23 is a member that emits sound by vibrating. The coupler 23 is a member that is disposed at the outer peripheral side of the first bobbin 21, that couples together the first bobbin 21 and the diaphragm 24, and that couples together the first bobbin 21 and the first damper 27.

As illustrated in FIG. 4, the coupler 23 basically has a configuration that is axially symmetric with respect to the center axis O1.

As illustrated in FIG. 5, the coupler 23 includes a first horizontal part 61, a first vertical wall part 62, a first inclined part 63, a second horizontal part 64, a second vertical wall part 65, a third horizontal part 66, a second inclined part 67, a third vertical wall part 68, and a fourth horizontal part 69, extending from an inside edge part to an outside edge part.

These configurations have shapes that are axially symmetric with respect to the center axis O1, except for portions at which a concave part 23b, described below, is formed.

The first horizontal part 61 is a portion extending slightly inward in the radial direction from a rear end of the first vertical wall part 62. The first horizontal part 61 forms a circular hole that is coaxial with the center axis O1. In a state in which the first bobbin 21 is inserted into the circular hole, the outer peripheral face of the first bobbin 21 is joined to the first horizontal part 61 and the first vertical wall part 62.

The first vertical wall part 62 has a cylindrical shape. A slight gap in the radial direction is formed between the inner peripheral face of the first vertical wall part 62 and the outer peripheral face of the first bobbin 21. Adhesive is poured into the gap.

The first inclined part 63 has a shape that is inclined forward on progression toward the radial direction outer side. The first inclined part 63 facilitates the operation of pouring in the adhesive that bonds together the first bobbin 21 and the coupler 23.

The second horizontal part 64 is a portion extending outward in the radial direction from a front end of the first inclined part 63.

The second vertical wall part 65 has a cylindrical shape. An inside edge part 24a of the diaphragm 24 is joined to an outer peripheral face of the second vertical wall part 65.

An avoidance part 23a is formed by the first inclined part 63, the second horizontal part 64, and the second vertical wall part 65. The avoidance part 23a is provided in order to prevent the coupler 23 and the second bobbin 31 from interfering with each other when the speaker 10 is actuated. Namely, the avoidance part 23a is a portion of the first vibration part 20 that is shaped so as to escape toward the front side in order to prevent interference with the second bobbin 31.

The third horizontal part 66 is a portion extending slightly outward in the radial direction from a rear end of the second vertical wall part 65. The second inclined part 67 has a shape that is inclined rearward on progression toward the radial direction outer side. The third vertical wall part 68 is a portion extending slightly rearward from a rear end of the second inclined part 67.

The fourth horizontal part 69 is a portion extending outward in the radial direction from a rear end of the third vertical wall part 68. The fourth horizontal part 69 configures an outside edge part of the coupler 23. The elastic body 27A of the first damper 27 is joined to a front face of the fourth horizontal part 69 by an adhesive or the like.

As illustrated in FIG. 4, the coupler 23 has two concave parts 23b. The two concave parts 23b are formed at positions that are symmetrical in the Y direction. At the portion at which the concave part 23b is formed, the front face of the coupler 23 is recessed toward the rear side and the radial direction inner side. Each concave part 23b is formed in a region extending in the X direction, as viewed from the +Z direction, which is the front side.

Specifically, the concave part 23b includes a first horizontal face 23b1, a vertical face 23b2, and a second horizontal face 23b3. The first horizontal face 23b1 is a face formed by recessing the front face of the second horizontal part 64 toward the rear, and has a normal direction that is directed to the front. The vertical face 23b2 is a face formed by the second vertical wall part 65, the third horizontal part 66, the second inclined part 67, and the third vertical wall part 68 being recessed inward in the radial direction, and has a normal direction that is directed outward in the radial direction. The second horizontal face 23b3 is a face formed by recessing the third horizontal part 66, the second inclined part 67, and the third vertical wall part 68 toward the rear, and has a normal direction that is directed to the front. The second horizontal plane 23b3 is formed on the same plane as the front face of the fourth horizontal part 69.

Further, the coupler 23 is formed by insert molding in which two relay members 23c are insert products. The two relay members 23c are conductive members, and are disposed at positions corresponding to the two concave parts 23b. The two relay members 23c have the same configuration as each other.

The relay member 23c is a member obtained by bending an elongated plate member. The relay member 23c includes a first extension part 23cl extending in the axial direction, and a second extension part 23c2 extending in a direction (X direction) perpendicular to the axial direction. The plate member configuring the relay member 23c is folded at a right angle at the rear end part of the first extension part 23c1, and the second extension part 23c2 extends in the +X direction from this portion.

A portion at the front end side of the first extension part 23c1 protrudes forward from the first horizontal face 23b1 of the concave part 23b of the coupler 23, and wiring (not illustrated) that is linked to the first coil 22 is connected to this portion by soldering. In this manner, a portion of the front end side of the first extension part 23cl protrudes forward from the first horizontal face 23b1 of the concave part 23b, and the front-rear dimension of the first extension part 23c1 can be reduced while the front-rear dimension of the protruding portion is secured.

A front face of a portion of the second extension part 23c2 at the +X direction side is exposed at the front face of the second horizontal face 23b3 of the concave part 23b of the coupler 23 and at the fourth horizontal part 69, and the inside connection part 81a of the belt-shaped wiring 81 that is integral with the elastic body 27A of the first damper 27 is joined to this portion by soldering.

### Second Vibration Part 30

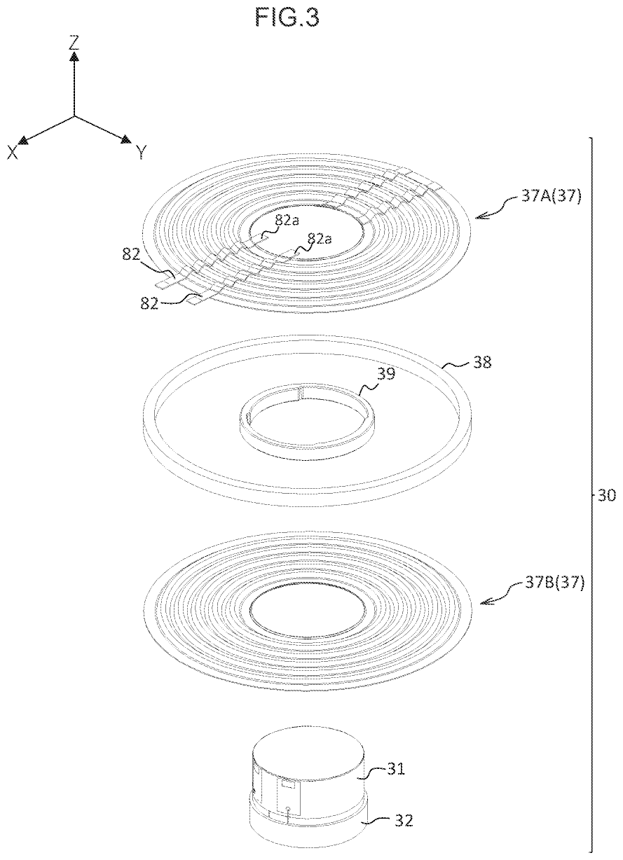

As illustrated in FIGS. 1 and 3, the second vibration part 30 includes a second bobbin 31, a second coil 32, a second damper 37, a spacer 38, and a weight 39.

The second bobbin 31 has a cylindrical shape that is coaxial with the center axis O1. The second bobbin 31 has a larger diameter than the first bobbin 21.

The second coil 32 is formed by being wound around an outer peripheral surface of a rear end part of the second bobbin 31.

In the inactive state illustrated in FIG. 1 (a state in which the speaker 10 is not actuated), the front end of the second bobbin 31 is positioned further toward the front side than the rear end of the first bobbin 21.

The second damper 37 supports the second bobbin 31 so as to be capable of vibrating in the axial direction with respect to the frame 50.

The second damper 37 includes a first elastic body 37A and a second elastic body 37B that are disposed with a gap therebetween in the axial direction. Each of the first elastic body 37A and the second elastic body 37B has a circular hole at the center that is coaxial with the center axis O1, is an elastic body in the shape of a disk extending outward in the radial direction from an inside edge part forming the circular hole, and has a corrugated shape. The first elastic body 37A and the second elastic body 37B have substantially the same configuration. As a result, when the first elastic body 37A and the second elastic body 37B move in parallel in the axial direction, their cross-sectional shapes overlap with each other.

A spacer 38 that maintains an axial direction distance between the first elastic body 37A and the second elastic body 37B is provided at an outside edge part of the second damper 37. A rear face of the outside edge part of the second elastic body 37B is joined to the frame 50. An inside edge part of the first elastic body 37A and an inside edge part of the second elastic body 37B are joined to an outer peripheral face of the second bobbin 31.

Two belt-shaped wirings 82 (wirings, transmission paths) are integrated with the first elastic body 37A. Each belt-shaped wiring 82 is provided following the shape of the first elastic body 37A at the front side of the first elastic body 37A. Namely, each belt-shaped wiring 82 has a waveform shape.

The two belt-shaped wirings 82 are disposed at positions that are symmetrical in the Y direction, and respectively extend in parallel along the X direction. An inside connection part 82a of the belt-shaped wiring 82 is connected to a transmission path formed at the outer peripheral surface of the second bobbin 31.

The weight 39 is provided in order to increase the mass of a vibration part that is supported by the second damper 37. As a result of increasing the mass of the vibration part that is supported by the second damper 37, the amplitude amount of the second vibration part 30 can be reduced while maintaining the effect of cancelation of vibration of the entire speaker 10 by the second vibration part 30.

The weight 39 is annular in shape, and has an annular shape following the cylindrical shape of the second bobbin 31. The weight 39 is provided in the vicinity of the inside edge part of the second damper 37. Specifically, it is disposed between the first elastic body 37A and the second elastic body 37B in the vicinity of the inside edge part of the second damper 37. As a result, the weight 39 is disposed so as to surround the second bobbin 31.

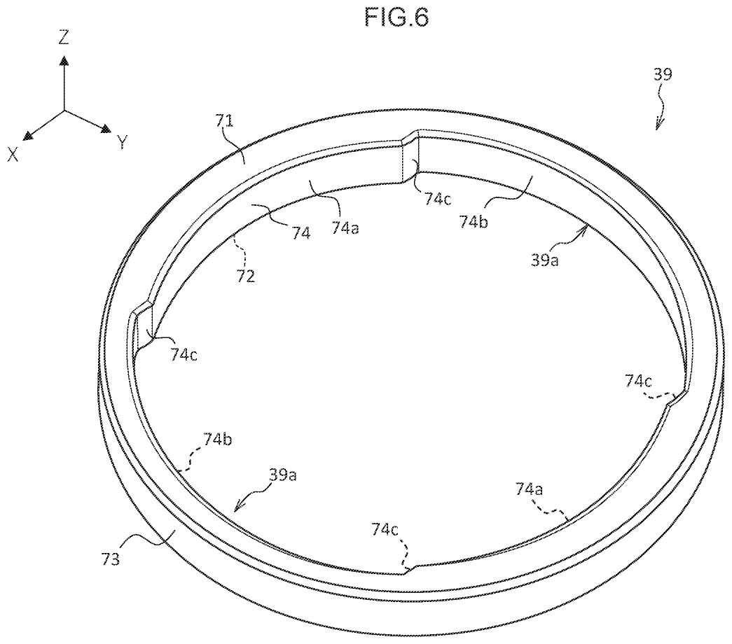

FIG. 6 is an enlarged perspective view of the weight 39. The weight 39 has two concave parts 39a. Because the weight 39 has the concave parts 39a, at a part in the circumferential direction at which the concave part 39a is formed, a gap between an inner peripheral face of the weight 39 and an outer peripheral face of the second bobbin 31 is increased. The two concave parts 39a are formed at positions facing each other with the center axis O1 therebetween. One of the two concave parts 39a is formed in a range including positions at which the inside connection parts 82a of the two belt-shaped wires 82 described above are connected to a transmission path formed at the outer peripheral face of the second bobbin 31.

Specifically, the weight 39 includes a front face 71, a rear face 72, an outer peripheral face 73, and an inner peripheral face 74. The front face 71 is a flat face that faces its normal direction toward the front, and the rear face 72 is a flat face that faces its normal direction toward the rear. The outer peripheral face 73 is a curved face that faces its normal direction toward the radial direction outer side, and is formed on a single circumference centered on the center axis O1 as viewed from the axial direction. The inner peripheral face 74 includes a first inner peripheral face 74a corresponding to a circumferential direction position at which the concave part 39a is not formed, and a second inner peripheral face 74b corresponding to a circumferential direction position at which the concave part 39a is formed. Two first inner peripheral surfaces 74a are formed, and two second inner peripheral surfaces 74b are formed. The first inner peripheral face 74a and the second inner peripheral face 74b are both curved faces with their normal directions directed inward in the radial direction, and are formed on an arc centered on the center axis Ol as viewed from the axial direction.

Further, the weight 39 has a connection face 74c that connects the first inner peripheral face 74a and the second inner peripheral face 74b. Two connection faces 74c are formed with respect to one second inner peripheral surface 74b. The two connection faces 74c face a direction (Y direction) facing each other. In other words, the two connection surfaces 74c are parallel with each other.

### Magnetic Circuit 40

As illustrated in FIG. 1, the magnetic circuit 40 includes a first magnetic member 41 (a top plate), a first magnet 42, an intermediate magnetic member 43 (a first yoke), a second magnet 44, and a second magnetic member 45 (a second yoke). The magnetic circuit 40 is formed by stacking the second magnet 44, the intermediate magnetic member 43, the first magnet 42, and the first magnetic member 41 coaxially in this order from the second magnetic member 45 disposed at the rearmost side.

A magnetic circuit corresponding to the first vibration part 20 and the second vibration part 30 is configured with a single magnetic circuit 40, and by configuring in this way such that the magnetic circuit 40 is stacked from the rear, assembly properties in the manufacturing process are improved.

The second magnetic member 45 includes a disk-shaped bottom part 45a, a cylindrical part 45b that stands toward the front from an outside edge part of the bottom part 45a, a columnar convex part 45c protruding outward toward the front from a center part of the bottom part 45a, and an attachment flange 45d extending outward in the radial direction from a front end of the cylindrical part 45b. The attachment flange 45d is attached to the frame 50. A recess 45al is provided at a rear face of the bottom part 45a.

The second magnet 44 is joined to the front face of the convex part 45c. The second magnet 44 has a columnar shape. The diameter of the second magnet 44 is larger than the diameter of the first magnet 42.

The intermediate magnetic member 43 is joined to the front face of the second magnet 44. The intermediate magnetic member 43 includes a disk-shaped bottom part 43a, a cylindrical part 43b that stands toward the front from a peripheral edge of the bottom part 43a, and a columnar convex part 43c that protrudes outward toward the front from a center part of the bottom part 43a.

The first magnet 42 is joined to the front face of the convex part 43c. The first magnet 42 has a columnar shape. The diameter of the first magnet 42 is substantially the same as the diameter of the convex part 43c.

The first magnetic member 41 is joined to the front face of the first magnet 42. The first magnetic member 41 has a columnar shape. The diameter of the first magnetic member 41 is slightly larger than the diameter of the first magnet 42.

The diameter of the bottom part 43a of the intermediate magnetic member 43 is larger than the diameter of the cylindrical part 43b. As a result, an outer peripheral part 43al of the bottom part 43a protrudes further outward in the radial direction than an outer peripheral surface of the cylindrical part 43b. The outer peripheral part 43al of the bottom part 43a is referred to as an outside protruding part 43a1.

Further, a front end of the cylindrical part 45b of the second magnetic member 45 substantially coincides with the position in the front-rear direction of the front face of the bottom part 43a of the intermediate magnetic member 43.

As a result, the outside protruding part 43al is opposed to the front end part of the cylindrical part 43b of the second magnetic member 45 in the radial direction.

A front end of the cylindrical part 43b of the intermediate magnetic member 43 is positioned further forward than the front face of the first magnetic member 41.

An annular gap is formed between the inner peripheral surface of the cylindrical part 43b of the intermediate magnetic member 43 and the outer peripheral surfaces of the first magnetic member 41, the first magnet 42, and the convex part 43c. Within this gap, a substantially uniform magnetic field is generated in the circumferential direction in a first magnetic gap G1 formed between the outer peripheral face of the first magnetic member 41 and the inner peripheral face of the cylindrical part 43b.

The bottom part 43a of the intermediate magnetic member 43, the second magnet 44, and the protruding part 45c of the intermediate magnetic member 43 are positioned at an inner side of the cylindrical part 45b of the intermediate magnetic member 43. An annular gap is formed between the inner peripheral surface of the cylindrical part 45b and the outer peripheral surfaces of the bottom part 43a, the second magnet 44, and the convex part 45c. Within this gap, a substantially uniform magnetic field is generated in the circumferential direction in a second magnetic gap G2 formed between an outer peripheral face of the bottom part 43a (an outer peripheral face of the outside protruding part 43a1) and an inner peripheral face of the cylindrical part 45b.

By adjusting the protrusion amount of the outside protruding part 43a1, the spacing of the second magnetic gap G2 can be narrowed, and magnetic flux passing through the second magnetic gap G2 can be increased, and leakage flux can be reduced.

### Frame 50

The frame 50 includes a first support part 51 that supports the outside edge part 25b of the edge 25, a second support part 52 that supports the outside edge part 27b of the first damper 27, and a third support part 53 that supports the outside edge part of the second damper 37.

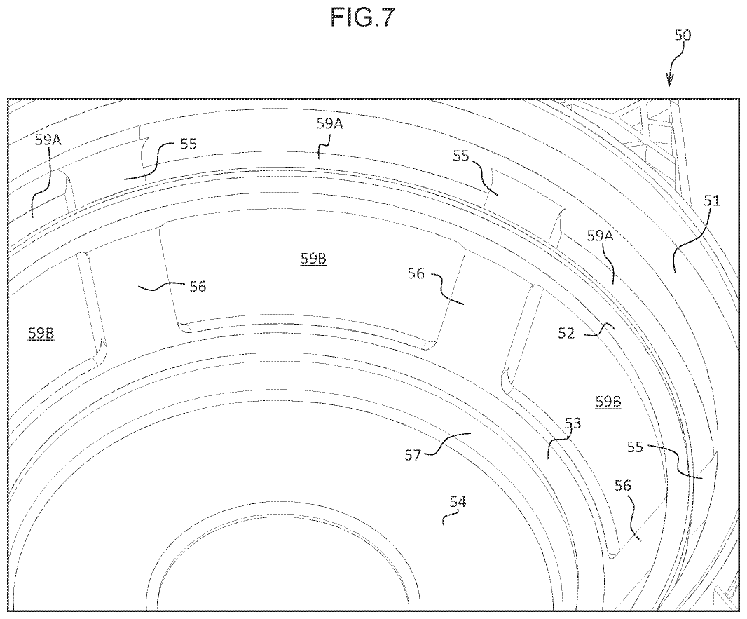

As illustrated in FIG. 7, the first support part 51, the second support part 52, and the third support part 53 are all formed continuously on circumferences centered on the center axis O1. The first support part 51, the second support part 52, and the third support part 53 are respectively joined to the edge 25, the first damper 27, and the second damper 37 at faces oriented toward the front. The first support part 51 is positioned at the foremost side, and the third support part 53 is positioned at the most rearmost side. The diameter of the first support part 51 is the largest, and the diameter of the third support part 53 is the smallest.

The frame 50 includes a first coupling part 55 that couples together the first support part 51 and the second support part 52. As illustrated in FIG. 7, plural first coupling parts 55 are provided that are separated in the circumferential direction. As a result, plural first openings 59A are formed between the first support part 51 and the second support part 52.

The frame 50 includes a second coupling part 56 that couples together the second support part 52 and the third support part 53. As illustrated in FIG. 7, plural second coupling parts 56 are provided that are separated in the circumferential direction. As a result, plural second openings 59B are formed between the second support part 52 and the third support part 53. The positions in the circumferential direction at which the second coupling parts 56 are provided coincide with the first coupling parts 55.

The frame 50 includes a fourth support part 54 that supports the magnetic circuit 40. The plate thickness direction of the fourth support part 54 is oriented in the axial direction. Further, the frame 50 includes a third coupling part 57 that couples together the third support part 53 and the fourth support part 54. The third coupling part 57 is formed continuously in the circumferential direction. As a result, no opening is formed between the third support part 53 and the fourth support part 54.

Next, explanation follows regarding the relationships between the magnetic circuit 40, the first vibration part 20, and the second vibration part 30.

The first coil 22 is disposed in the first magnetic gap G1. The first coil 22 is connected to the transmission path. The first bobbin 21 vibrates together with the first coil 22 under the action of an electric signal from the transmission path and the magnetic field of the first magnetic gap G1, as a result of which, the first vibration part 20 vibrates. As a result of this, sound is emitted.

At this time, a first excitation force is generated in the speaker 10 in response to vibration of the first vibration part 20. The first excitation force causes the housing fixed to the speaker 10 to vibrate.

The second coil 32 is disposed in the second magnetic gap G2. The second coil 32 is connected to the same transmission path as the first coil 22, and the second bobbin 31 vibrates together with the second coil 32 under the action of the electric signal from the transmission path and the magnetic field of the second magnetic gap, as a result of which, the second vibration part 30 vibrates.

The first vibration part 20 and the second vibration part 30 are configured so as to operate in mutually reversed phases. Specifically, when the first vibration part 20 is displaced forward, the second vibration part 30 is displaced rearward, and when the first vibration part 20 is displaced rearward, the second vibration part 30 is displaced forward. Actuation of the first vibration part 20 and the second vibration part 30 in mutually reversed phases can be realized by adjusting the magnetization direction of each magnet, the direction in which electric current flows, and the winding direction of the coils.

### Mechanism and Effects

Explanation follows regarding operation and advantageous effects of the present exemplary embodiment.

In the present exemplary embodiment, as illustrated in FIG. 1, the speaker 10 is provided with a frame 50, a magnetic circuit 40, and a first vibration part 20 that vibrates to emit sound. The first vibration part 20 includes a first bobbin 21, a first coil 22, a first damper 27, and a diaphragm 24. The first coil 22 and the first bobbin 21 are elastically supported with respect to the frame 50 by the first damper 27, and when the first coil 22 is driven in cooperation with the magnetic circuit 40, the diaphragm 24 vibrates and emits sound.

Further, in the present exemplary embodiment, the speaker 10 further includes a second vibration part 30 that vibrates in order to cancel vibration of the entire speaker 10 by the first vibration part 20. The second vibration part 30 includes a second bobbin 31, a second coil 32, and a second damper 37. As a result, vibration of the first vibration part 20 that is transmitted to the frame 50 is cancelled. Further, generation of unnecessary vibration transmitted to the frame 50 can be suppressed, and vibration of the speaker 10 can be suppressed. As a result, degradation of sound quality due to vibration of the speaker 10 is suppressed.

However, in the conventional art in which the inside edge part 24a of the diaphragm 24 is directly joined to the first bobbin 21, in order to secure appropriate rigidity of the diaphragm 24 and suppress reverse vibration, a large incline may be provided in the vicinity of the inside edge part of the diaphragm 24. However, if a large incline is provided in the vicinity of the inside edge of the diaphragm 24, the height dimension (overall height, front-rear dimension) of the diaphragm 24 is increased, which has the result of being disadvantageous in terms of reducing the thickness of the speaker 10.

Therefore, in the present exemplary embodiment, the first vibration part 20 includes the coupler 23. Further, an inside edge part 24a of the diaphragm 24 is disposed at a gap outward in the radial direction from an outer peripheral surface of the first bobbin 21, and the inside edge part 24a of the diaphragm 24 and the first bobbin 21 are coupled by the coupler 23.

That is, the vicinity of the inside edge part of the diaphragm in the above-described conventional art is replaced with a coupler 23. As a result, without increasing the height dimension of the diaphragm 24, it is easy to secure the rigidity of a member configured including the coupler 23 and the diaphragm 24. As a result, the speaker 10 can be made thinner while suppressing reverse vibration of the diaphragm 24.

Further, in the present exemplary embodiment, the coupler 23 includes an avoidance part 23a that prevents interference with the second bobbin 31. As a result, compared to an aspect in which the coupler 23 does not include the avoidance part 23a, the first vibration part 20 and the second vibration part 30 can be disposed closer together. As a result, the speaker 10 can be made thinner.

In particular, in the present exemplary embodiment, although not illustrated in the drawings, in a state in which the first bobbin 21 and the second bobbin 31 are closest to each other in the front-rear direction, the front end of the second bobbin 31 is positioned inside the avoidance part 23a.

Further, in the present exemplary embodiment, an inside edge part 27a of the first damper 27 is disposed at a gap outward in the radial direction from an outer peripheral surface of the first bobbin 21, and the inside edge part 27a of the first damper 27 and the first bobbin 21 are coupled by the coupler 23.

That is, coupling between the diaphragm 24 and the first bobbin 21, and coupling between the first damper 27 and the first bobbin 21, are realized by the coupler 23.

As a result, compared to embodiments in which coupling between the diaphragm 24 and the first bobbin 21 and coupling between the first damper 27 and the first bobbin 21 are separately realized at different positions in the front-rear direction, the speaker 10 can be made thinner.

Further, in the present exemplary embodiment, the inside edge part 24a of the diaphragm 24 is positioned at an inner side in the radial direction of the inside edge part 27a of the first damper 27. As a result, assembly properties of the first vibration part 20 including the coupler 23, the diaphragm 24, and the first damper 27 are favorable.

Further, in the present exemplary embodiment, as illustrated in FIG. 4, the coupler 23 has a concave part 23b corresponding to a position at which a transmission path is disposed. As a result, the transmission path can be easily arranged.

Further, in the present exemplary embodiment, as illustrated in FIG. 4, the coupler 23 is molded with the conductive relay member 23c as an insert product. As a result, the relay member 23c inserted in the coupler 23 enables a transmission path linked to the first coil 22 and a transmission path linked to the outside of the speaker 10 to be relayed.

Further, in the present exemplary embodiment, as illustrated in FIG. 1, the first vibration part 20 has an edge 25 that elastically supports the outside edge part 24b of the diaphragm 24. Further, the outside edge part 27b of the first damper 27 is positioned further toward the outside in the radial direction than the outside edge part 24b of the diaphragm 24.

As a result, the first damper 27 is positioned behind the outside edge part 24b of the diaphragm 24, and interference between the outside edge part 24b of the diaphragm 24 and other members can be suppressed. As a result, the distance between the diaphragm 24 and the first damper 27 in the front-rear direction can be made small, and the speaker 10 can be reduced in thickness.

Incidentally, because the first damper 27 and the second damper 37 are displaced in opposite directions, the volume of the space between the first damper 27 and the second damper 37 inside the speaker 10 greatly fluctuates.

Here, in the present exemplary embodiment, the frame 50 includes a second opening 59B (see FIG. 7) that links the space between the first damper 27 and the second damper 37 inside the speaker 10, with a space outside the speaker 10. As a result, air can escape from the space between the first damper 27 and the second damper 37 inside the speaker 10.

Further, in the present exemplary embodiment, as illustrated in FIG. 1, the coupler 23 includes a vertical wall part 65 contacting the inside edge part 24a of the diaphragm 24.

As a result, the vertical wall part 65 of the coupler 23 serves as a guide, enabling the diaphragm 24 to be disposed at a desired position with respect to the coupler 23.

Further, in the present exemplary embodiment, the magnetic circuit 40 includes a first magnet 42, a second magnet 44, a first magnetic member 41 attached to the first magnet 42, a second magnetic member 45 attached to the second magnet 44, and an intermediate magnetic member 43 attached to both the first magnet 42 and the second magnet 44. The intermediate magnetic member 43 forms a first magnetic gap G1 between itself and the first magnetic member 41, and forms a second magnetic gap G2 between itself and the second magnetic member 45.

As a result, the intermediate magnetic member 43 can be used as a pathway for both the magnetic flux passing through the first magnetic gap G1 and the magnetic flux passing through the second magnetic gap G2, and reduction of the thickness of the magnetic circuit 40 can be achieved.

Further, in the present exemplary embodiment, the second vibration part 30 includes a weight 39. As a result, compared to an aspect in which the second vibration part 30 does not include the weight 39, the amplitude amount of the second vibration part 30 can be reduced while maintaining the effect of canceling vibration of the entire speaker 10. As a result, the speaker 10 can be made thinner.

Further, in the present exemplary embodiment, the second bobbin 31 protrudes outward and forward (upward) from the weight 39. In other words, the weight 39 does not protrude outward and forward with respect to the second bobbin 31. As a result, compared to an aspect in which the weight 39 is disposed so as to be hooked to the front end of the second bobbin 31, for example, the speaker 10 is easily reduced in thickness.

Further, in the present exemplary embodiment, the second damper 37 includes two elastic bodies 37A, 37B. As a result, the movement symmetry and rectilinearity of the second vibration part 30 at the time of amplitude are improved. Further, the weight 39 is disposed between the two elastic bodies 37A, 37B. As a result, the weight 39 does not adversely affect the thickness reduction of the speaker 10.

Further, in the present exemplary embodiment, as illustrated in FIG. 6, the weight 39 includes a concave part 39a that enlarges a spacing between the weight 39 and the second bobbin 31 at a part in a circumferential direction. As a result, in a case in which soldering or the like is performed at the outer peripheral face of the second bobbin 31, by providing the concave part 39a so as to correspond to the portion to be soldered, short-circuiting between the second bobbin 31 and the weight 39 due to solder debris, other metal components, or the like can be suppressed.

Further, as illustrated in FIG. 3, in the present exemplary embodiment, the second damper 37 includes the first elastic body 37A that is integral with the transmission path (the belt-shaped wiring 82). As a result, there is no need to provide an arrangement space for the transmission path, thereby contributing to reduced thickness of the speaker 10.

### Second Exemplary Embodiment

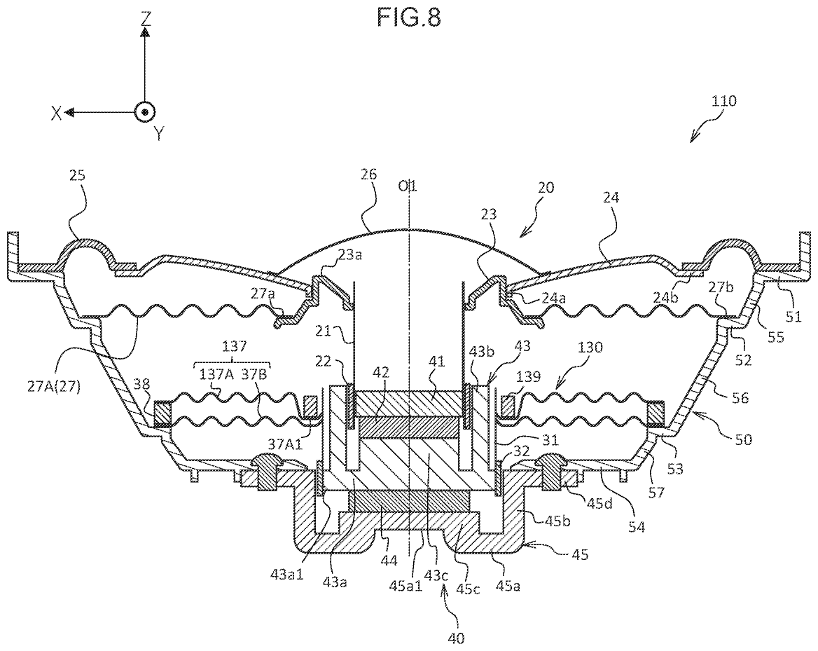

FIG. 8 illustrates a speaker 110 according to a second exemplary embodiment.

In the second exemplary embodiment, the configuration of the second vibration part 130 is different from the second vibration part 30 of the first exemplary embodiment.

The second vibration part 130 includes a second damper 137. The second damper 137 includes a first elastic body 137A and a second elastic body 37B that are disposed so as to overlap each other in the vibration direction. Further, the first elastic body 37A has a recessed part 37A1 recessed in a direction approaching the second elastic body 37B in the vibration direction, and a weight 139 is disposed on a face of the recessed part 37A1 at an opposite side from the second elastic body 37B. As a result, there is no need to perform an operation to arrange the weight 39 between the first elastic body 137A and the second elastic body 37B, and dimensional expansion of the second vibration part 30 in the amplitude direction can be suppressed.

### Supplementary Explanation

Above, preferred embodiments of the present invention have been explained in detail; however, the present invention is not limited to the above-described exemplary embodiments. Below, supplementary explanation is provided as a precaution.

The materials of the respective portions of the first vibration part 20 and the second vibration parts 30, 130 are not particularly limited. Various materials, such as paper-based, resin-based, metal-based, or a composite-type or ceramic-type in which these materials are combined, can be used for the diaphragm 24, the first damper 27, the elastic bodies 37A, 37B, and the cap 26, for example. Further, as the edge 25, a polymer-based material of relatively high elasticity such as rubber or resin can be used. Further, in addition thereto, a fiber material may be used as the material of each portion in the first vibration part 20 and the second vibration parts 30, 130. In addition, each part of the first vibration part 20 and the second vibration parts 30, 130 may be coated with a rubber coat or the like on a material serving as a base. As the frame 50 and the spacer 38, a resin-based or paper-based material, a metal-based nonmagnetic material, or the like can be used.

The diameters and thicknesses of the respective members illustrated in the respective drawings are examples, and are not limited to these shapes and sizes.

In the above-described exemplary embodiments, explanation has been given regarding an example in which the coupler 23 is joined to a single elastic body (the elastic body 27A); however, the present disclosure is not limited thereto. The coupler may be joined to two or more elastic bodies.

Further, in the above-described exemplary embodiments, explanation has been given regarding an example in which the diaphragm 24 and the first damper 27 are joined to the coupler 23; however, other components (for example, a cap) may also be joined to the coupler.

In the above-described exemplary embodiments, an example has been described in which the concave part 23b is formed at a position corresponding to the entirety of the transmission path provided in the coupler 23; however, the concave part of the present disclosure is not limited thereto. The concave part may be formed in at least a portion of a position at which the transmission path is provided.

Further, in cases in which a relay component is provided at the coupler, the coupler need not have a concave part.

In the above-described exemplary embodiments, explanation has been given regarding an example in which the coupler 23 is molded using the conductive relay component 23c as an insert product; however, relay components of the present disclosure are not limited thereto. The relay component may be retained in the coupler by a different method from insert molding.

Further, the configuration of the weight 39 is also not limited to the above-described exemplary embodiments.

For example, the weight may be attached to the inner peripheral face side of the bobbin. Further, the weight may be attached to the front end of the bobbin. Further, the shape of the weight is not limited to an annular shape, and may be, for example, a polygonal shape or may have a notch. Further, the weight need not have a concave part. Further, the weight may contact the voice coil in an insulated state.

Further, the configuration of the second damper 37 is also not limited to the above-described exemplary embodiments.

For example, the second damper may have one or three or more elastic bodies. Further, instead of providing the spacer 38, two elastic bodies may be attached to the frame by providing a step in the frame.

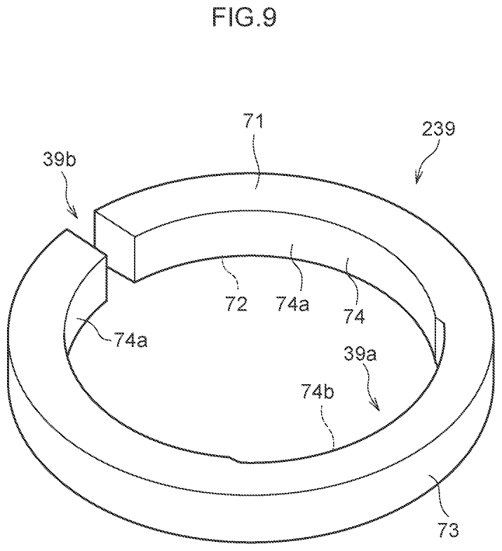

FIG. 9 is a perspective view illustrating a weight 239 according to a modified example.

While the weight 239 is substantially annular (specifically, has a substantially annular shape), since a notch 39b is formed at a single location on the circumference, the weight 239 has an arcuate shape, and the ring is not complete. That is, the shape of the weight 239 is substantially annular including a notch 39b at one part on the circumference.

The weight 239 is a metal material, and is made of a non-magnetic material such as aluminum.

The weight 239 has a concave part 39a. Because the weight 239 has the concave part 39a, at a circumferential direction part at which the concave part 39a is formed, the spacing between the inner peripheral face of the weight 239 and the outer peripheral face of the second bobbin 31 is increased. The concave part 39a is formed in a range including positions at which the inside connection parts 82a (see FIG. 3) of the two belt-shaped wirings 82 described above are connected to a transmission path formed at the outer peripheral face of the second bobbin 31. The position at which the concave part 39a is provided is a position at an opposite side to the notch 39b, with the center axis O1 (the center axis serving as the vibration axial center of the second vibration part 30) of the speaker 10 therebetween.

The size of the notch 39b is set such that the center of gravity of the weight 239 is positioned on the center axis O1 of the speaker 10. Specifically, since the notch 39b is formed at the opposite side to the concave part 39a with the center axis O1 therebetween, by setting the size of the notch 39b to an appropriate size, the center of gravity of the weight 239 can be brought closer to the center axis O1. As a result, the center of gravity of the weight 239 and the center axis O1 of the speaker 10 can be made substantially the same; namely, the center of gravity of the weight 239 and the center axis of the second vibration part 30 can be made substantially the same, and rolling of the second vibration part 30 can be suppressed and the linearity of vibration of the second vibration part 30 can be satisfied. Substantially the same center of gravity of the weight 239 as the center axis of the second vibration part 30 (the center axis O1 of the speaker 10) is allowable to the extent that the amplitude movement of the second vibration part 30 is not hindered.

Here, in the example illustrated in FIG. 9, the outer peripheral face 73 and the inner peripheral face 74 of the weight 239 extend in an arc shape centered on the center axis Ol of the speaker 10.

Next, explanation is given regarding the mechanism and effects of the modified example.

In order to manufacture the speaker 10, a process of magnetizing the second magnet 44 included in the magnetic circuit 40 (hereafter, referred to as a magnetizing process) is necessary. Further, the magnetization process may be performed in a state in which the magnetic circuit 40 and the second vibration part 30 are assembled with the frame 50.

Here, if the weight 239 is a complete ring, current flows through the weight 239 in an annular manner and force is generated during the magnetization process, and a strong force is unnecessarily applied to the weight 239.

Therefore, in this modified example, the weight 239 includes the notch 39b.

As a result, during the magnetization process, current is prevented from flowing through the weight 239 in an annular manner, and a strong force is prevented from acting on the weight 239.

Further, in this modified example, the weight 239 is made of a metal material. As a result, it is easy to secure the mass of the weight 239, and to secure the driving force of the second vibration part 30.

Further, when the weight 239 is made of a magnetic material such as iron, the weight 239 receives unnecessary force from a magnetic field generated by the magnetic circuit 40.

Here, in this modified example, the weight 239 is made of a non-magnetic material such as aluminum.

As a result, the weight 239 is prevented from receiving an unnecessary force from a magnetic field generated by the magnetic circuit 40.

The disclosure of Japanese Patent Application No. 2023-004734, filed Jan. 16, 2023, is hereby incorporated by reference in its entirety.

### EXPLANATION OF REFERENCE SYMBOLS

10 Speaker
20 First Vibration Part
21 First Bobbin
22 First Coil
23 Coupler
23a Avoidance Part
23b Concave Part
23c Relay Member
24 Diaphragm
24a Inside Edge
24b Outside Edge
25 Edge
27 First Damper
27a Inside Edge
27b Outside Edge
30 Second Vibration Part
31 Second Bobbin
32 Second Coil
37 Second Damper
37A First Elastic Body
37B Second Elastic Body
39 Weight
39a Concave Part
39b Notch
50 Frame
59B Second Opening (Opening)
65 Second Vertical Wall Part (Vertical Wall Part)
82 Band-shaped Wiring (Wiring)
110 Speaker
130 Second Vibration part
137 Second Damper
137A First Elastic Body
139 Weight
239 Weight
G1 First Magnetic Gap
G2 Second Magnetic Gap
O1 Center Axis

1. A speaker, comprising:
a magnetic circuit;
a first vibration part vibrating in order to emit sound and having a first bobbin, a first coil, a first damper and a diaphragm; and
a second vibration part vibrating in order to cancel vibration of the speaker as a whole that is due to the first vibration part, and having a second bobbin, a second coil, a second damper and a weight, wherein:
the magnetic circuit comprises:
a first magnet;
a first magnetic member attached to the first magnet;
a first yoke attached to the first magnet, a first magnetic gap being formed between the first yoke and the first magnetic member; and
a second yoke, a second magnetic gap being formed between the second yoke and the first yoke,
the weight is configured by a conductor that is a non-magnetic member, and
a shape of the weight is substantially annular, having a notch at a part of a circumference.

2. The speaker of claim 1, wherein the second bobbin protrudes upward relative to the weight.

3. The speaker of claim 1, wherein:
the second damper has two elastic bodies, and
the weight is disposed between the two elastic bodies.

4. The speaker of claim 1, wherein:
the second damper has a first elastic body and a second elastic body disposed so as to overlap with each other in a vibration direction,
the first elastic body has a recessed part recessed in a direction approaching the second elastic body in the vibration direction, and
the weight is disposed in the recessed part at a face at an opposite side from the second elastic body.

5. The speaker of claim 1, wherein:
the weight is disposed surrounding the second bobbin, and
the weight has a concave part enlarging a gap between the weight and the second bobbin at a part in a circumferential direction of the weight.

6. The speaker of claim 5, wherein a center of gravity of the weight and a center axis of the second vibration part are substantially the same.

7. The speaker of claim 1, wherein the second damper has an elastic body integrated with wiring.
